(19) United States
(12) Patent Application Publication
(10) Pub. No.: US 2011/0139903 A1
(43) Pub. Date: Jun. 16, 2011

(54) FLUID DISPENSING NOZZLE STRUCTURE

(76) Inventor: Yen-Liang CHIEN, Taipei (TW)

(21) Appl. No.: 13/037,022

(22) Filed: Feb. 28, 2011

Related U.S. Application Data
(63) Continuation-in-part of application No. 12/624,575, filed on Nov. 24, 2009.
Application No. 12/624,575 is a continuation-in-part of application No. 12/547,552, filed on Aug. 26, 2009.

(51) Int. Cl. B05B 1/26

(52) U.S. Cl. 239/498

(57) ABSTRACT

A improved fluid dispensing nozzle structure is disclosed. The improved fluid dispensing nozzle structure of the present invention comprises a spout portion, an L-shape tubular portion and an anti-splashing cap. A retaining portion is disposed at the front end of the spout portion and is in fluid communication with a path located in the spout portion. A first flow reducing member is disposed on the bending portion of the path. A flow stabilizing unit is provided at the second opening. A threaded external surface is disposed on the outside of the second opening. An anti-splashing cap may be optionally provided and connected with the L-shape tubular portion at the second opening. The improved fluid dispensing nozzle structure of the present invention can reduce the flow, slow down the speed of the flow, regulate the flow and concentrate the flow to avoid splash.

### CROSS REFERENCES RELATED TO THE APPLICATION

This application is a continuation-in-part of U.S. patent application Ser. No. 12/624,575 filed on Nov. 24, 2009.

The 12/624,575 is a continuation-in-part of U.S. patent application Ser. No. 12/547,552 filed on Aug. 26, 2009.

### BACKGROUND OF THE INVENTION

1. Field of the invention

The invention generally relates to a improved fluid dispensing nozzle structure. More particularly, the invention relates to a fluid dispensing nozzle structure that can substantially reduce the flow and the flowing speed and spread out the flow to avoid splashing during operation.

2. Description of the prior art

As of now, fluid dispensing spouts 1 have been widely used for liquid, lotions and bottles holding other types of fluids (for example, condiments, cleaners, and Syrup etc.). These fluid dispensing spouts 1 are easy to use. A user only has to lightly press the top portion of the spout to dispense the content out of the bottle.

Though they are easy to use, they have a big drawback. If the content is thick or viscous enough, the content would come out slowly when the spout is pressed. However, if the content is not thick or viscous enough, the content would rush out swiftly and cause splash (as illustrated in FIG. 1). Therefore, we often have to clean up the splash.

From the above, we can see that the fluid dispensing spout of the prior art has at least a major disadvantage and needs to be improved.

To eliminate the disadvantage of the fluid dispensing spout of the prior art, the inventor has put a lot of effort into the subject and has successfully come up with the improved fluid dispensing nozzle structure of the present invention.

### SUMMARY OF THE INVENTION

An object of the present invention is to provide a improved fluid dispensing nozzle structure that can substantially reduce the flow and the flowing speed of a relatively less viscous fluid and concentrate the flow to avoid splash.

Another object of the present invention is to provide a improved fluid dispensing nozzle structure that is structurally simple, easy to use and easy to be disassembled. The two flow reducing members and the flow stabilizing unit can guide the liquid so as to reducing the flow, speed, minimizing the spreading and regulating concentrically the flow of fluid.

To reach these objects, the improved fluid dispensing nozzle structure of the present invention is disclosed. The improved fluid dispensing nozzle structure of the present invention comprises a spout portion, an L-shape tubular portion and an anti-splashing cap. A retaining portion is disposed at the front end of the spout portion and is in fluid communication with a path located in the spout portion. A first (connective) opening is disposed on the proximal end of the L-shape tubular portion, and a second opening is disposed on the distal end of the L-shape tubular portion. The first (connective) opening and second opening are in fluid communication with a path located in the L-shape tubular portion and a first flow reducing member is disposed on the bending portion of the path. The L-shape tubular portion is connected with the spout portion through the engagement between the first (connective) opening and the retaining portion. A flow stabilizing unit is provided at the second opening. A second flow reducing member is centrally disposed in the anti-splashing cap and can guide and regulate the flow. At least one outlet is disposed by the second flow reducing member. The flow stabilizing unit has eight radially oriented members and can slow down the speed of the flow, guide the flow, regulate the flow and concentrate the flow. A threaded internal wall is disposed on the inside of the anti-splashing cap, so that the anti-splashing cap may be connected with the L-shape tubular portion. In addition, the L-shape tubular portion may be connected with the spout portion.

### BRIEF DESCRIPTION OF THE DRAWINGS

FIG. 1 is a side view illustrating a fluid dispensing spout of the prior art in use.

FIG. 2 is a partially exploded sectional view illustrating the improved fluid dispensing nozzle structure of the present invention.

FIG. 3 is a sectional view illustrating the improved fluid dispensing nozzle structure of the present invention in an assembled condition.

FIG. 4A is a sectional view of the L-shape tubular portion of the improved fluid dispensing nozzle structure of the present invention.

FIG. 4B is a bottom view of the L-shape tubular portion of the improved fluid dispensing nozzle structure of the present invention.

FIG. 5 is a sectional view illustrating the fluid dispensing nozzle assembled with tubular portion only of present invention in use.

FIG. 6 is a sectional view illustrating the improved fluid dispensing nozzle structure of the present invention in use.

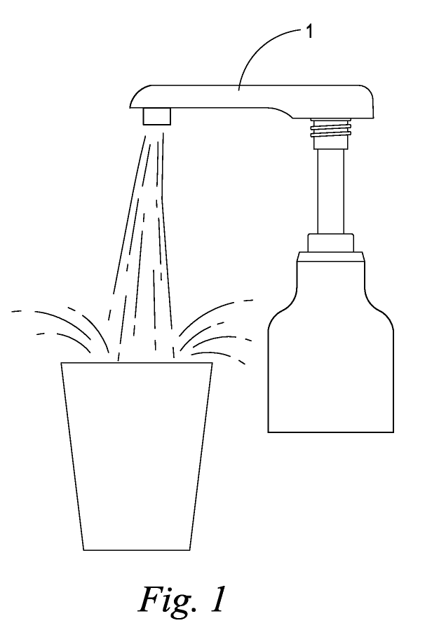

List of reference numerals

| | |
|---|---|
| 1 Spout | 2 Spout portion |
| 21 Retaining portion | 22 Path |
| 3 L-shape tubular portion | 31 First (connective) opening |
| 32 Second opening | 33 Threaded external surface |
| 34 Path | 35 First flow reducing member |
| 36 Flow stabilizing unit | 4 Anti-splashing cap |
| 41 Threaded internal wall | 42 Second flow reducing member |
| 43 Outlet | |

### DETAILED DESCRIPTION OF THE PREFERRED EMBODIMENT

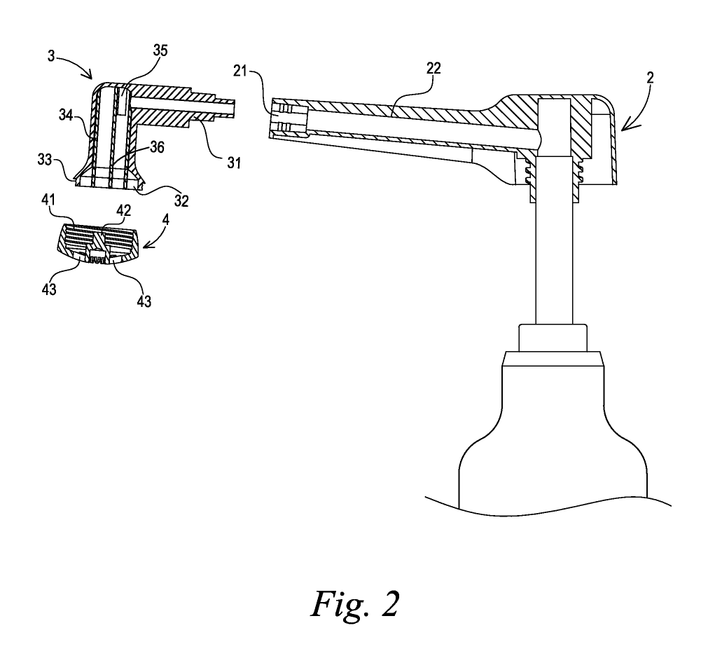

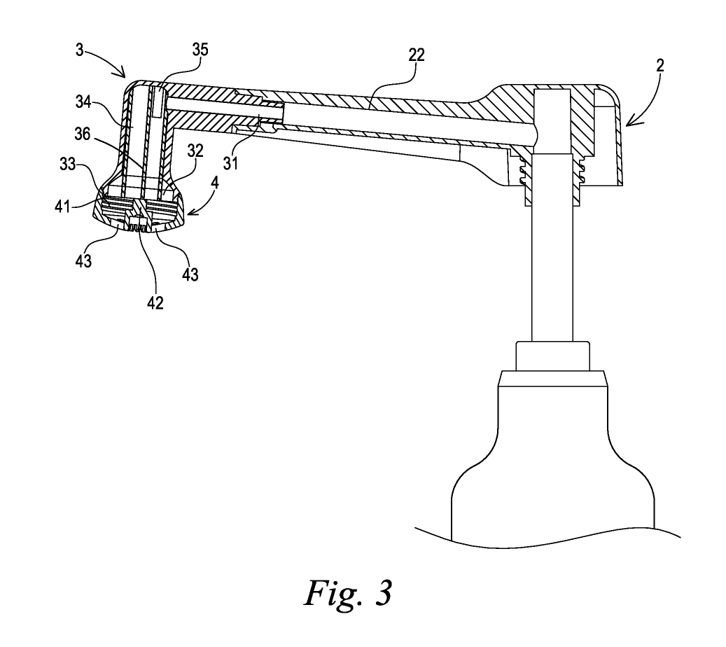

Please refer to FIGS. 2 and 3. FIG. 2 is a partially exploded sectional view illustrating the improved fluid dispensing nozzle structure of the present invention. FIG. 3 is a sectional view illustrating the improved fluid dispensing nozzle structure of the present invention in an assembled condition. The improved fluid dispensing nozzle structure of the present invention comprises a spout portion 2, an L-shape tubular portion 3 and an anti-splashing cap 4. A retaining portion 21 is disposed at the front end of the spout portion 2 and is in fluid communication with a path 22 located in the spout portion 2. A first (connective) opening 31 is disposed on the proximal end of the L-shape tubular portion 3, and a second opening 32 is disposed on the distal end of the L-shape tubular portion 3. A threaded external surface 33 is disposed on the outside of the second opening 32. The first (connective) opening 31 and second opening 32 are in fluid communication with a path 34 located in the L-shape tubular portion 3. A first flow reducing member 35 is disposed on the bending portion of the path 34. The L-shape tubular portion 3 may be connected with the spout portion 2 through the engagement between the first opening 31 and the retaining portion 21. A threaded internal wall 41 is disposed on the inside of the anti-splashing cap 4. A second flow reducing member 42 is centrally disposed in the anti-splashing cap 4. At least one outlet 43 is disposed by the second flow reducing member 42, so that fluid may come out through the outlet 43. The anti-splashing cap 4 may be positively connected with the L-shape tubular portion 3 through the engagement between the threaded internal wall 41 and the threaded external surface 33.

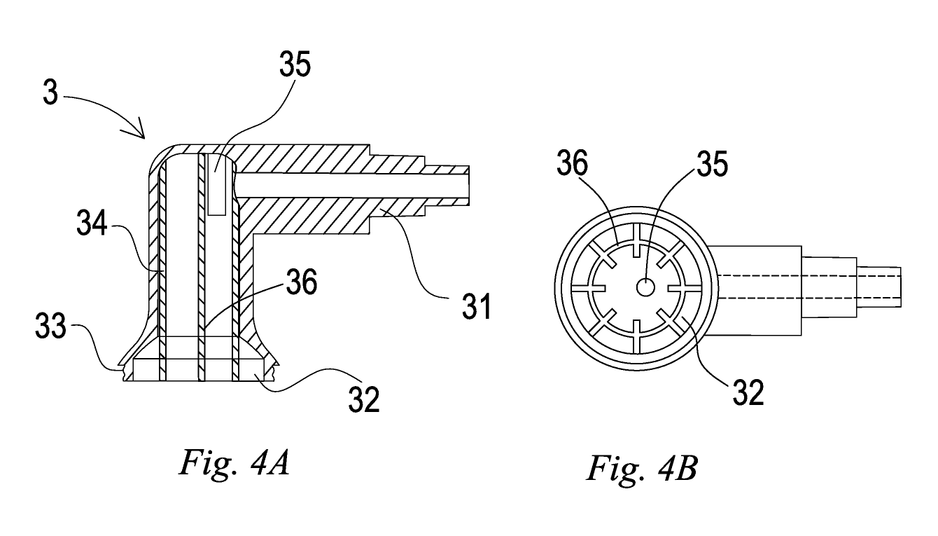

Now, please refer to FIGS. 4A and 4B. FIG. 4A is a sectional view of the L-shape tubular portion of the improved fluid dispensing nozzle structure of the present invention. FIG. 4B is a bottom view of the L-shape tubular portion of the improved fluid dispensing nozzle structure of the present invention. The first flow reducing member 35 is provided in the L-shape tubular portion 3 and is off the center of the cross section of the second opening 32. A flow stabilizing unit 36 is provided at the second opening 32. As illustrated in FIG. 4B, the flow stabilizing unit 36 has a plurality of radially oriented members and can slow down the speed of the flow, regulate the flow and concentrate the flow.

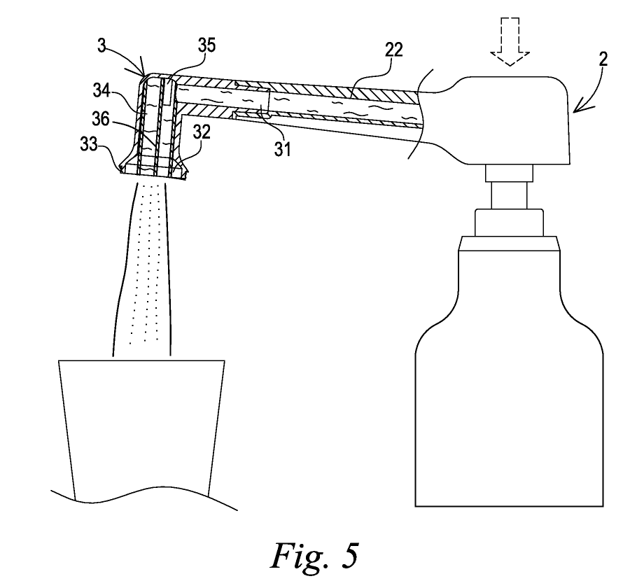

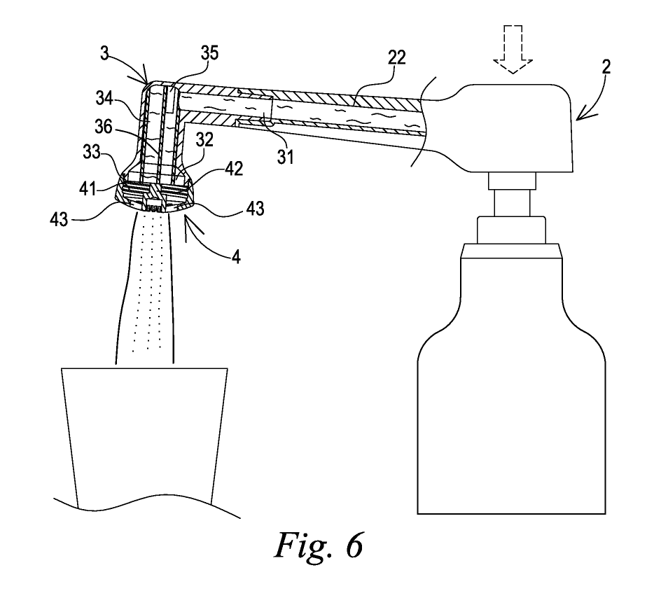

Please refer to FIG. 5 and FIG. 6, which is a sectional view of the improved fluid dispensing nozzle structure of the present invention in use. When a user presses the spout portion 2, the fluid would flow through the path 22 and the path 34. Now, the first flow reducing member 35 and the flow stabilizing unit 36 can guide, regulate and concentrate the flow so that the fluid may come out from the outlet 43 of the anti-splashing cap 4. The two members 35 and 42 and the flow stabilizing unit 36 can substantially reduce the flow and the flowing speed; therefore, splash may be avoided. Because the anti-splashing cap 4 is positively connected with the L-shape tubular portion 3 through the engagement between the threaded internal wall 41 and the threaded external surface 33, we can unscrew the unit 4 easily if we want to clean up the unit 4. In addition, the L-shape tubular portion 3 may be connected with the spout portion 2, as illustrated in FIG. 6.

In comparison to the prior art, the improved fluid dispensing nozzle structure of the present invention has the following advantages:

1. The improved fluid dispensing nozzle structure of the present invention can substantially reduce the flow and the flowing speed of a relatively less viscous fluid; therefore, splash may be avoided.
2. The improved fluid dispensing nozzle structure of the present invention is structurally simple, easy to use and easy to be disassembled. In addition, the flow stabilizing unit can slow down the speed of the flow, guide the flow, regulate the flow and concentrate the flow.

Although a preferred embodiment of the present invention has been described in detail hereinabove, it should be understood that the preferred embodiment is to be regarded in an illustrative manner rather than a restrictive manner, and all variations and modifications of the basic inventive concepts herein stated still fall within the scope of the present invention.

What is claimed is:

1. A improved fluid dispensing nozzle structure, comprising:
a spout portion, having a retaining portion, which is disposed at the front end of the spout portion and is in fluid communication with a path located in the spout portion;
an L-shape tubular portion, wherein a first (connective) opening is disposed on the proximal end of the L-shape tubular portion and a second opening is disposed on the distal end of the L-shape tubular portion, and wherein the first (connective) opening and second opening are in fluid communication with a path located in the L-shape tubular portion and a first flow reducing member is disposed on the bending portion of the path, and wherein the L-shape tubular portion may be connected with the spout portion through the engagement between the first opening and the retaining portion and a flow stabilizing unit is provided at the second opening; and
an anti-splashing cap, having at least a second flow reducing member and at least one outlet, wherein the outlet is disposed by the second flow reducing member, characterized in that the anti-splashing cap is positively connected with the L-shape tubular portion at the second opening.

2. The improved fluid dispensing nozzle structure as in claim 1, wherein a threaded external surface is disposed on the outside of the second opening and a threaded internal wall is disposed on the inside of the anti-splashing cap, characterized in that the anti-splashing cap may be positively connected with the L-shape tubular portion through the engagement between the threaded internal wall and the threaded external surface.

3. The improved fluid dispensing nozzle structure as in claim 1, wherein the L-shape tubular portion may be connected with the spout portion.
